(19) United States
(12) Patent Application Publication
(10) Pub. No.: US 2010/0300313 A1
(43) Pub. Date: Dec. 2, 2010

(54) Camouflage paint stencils

(76) Inventor: Warren Joseph Disbrow, Beaufort, SC (US)

Correspondence Address: THE INVENTORS NETWORK, INC., 332 ACADEMY STREET, CARNEGIE, PA, 15106, US

(21) Appl. No.: 12/455,211

(22) Filed: Jun. 1, 2009

(51) Int. Cl. B05C 17/06

(52) U.S. Cl. 101/128

(57) ABSTRACT

Camouflage paint stencils for painting camouflage patterns on a vehicle, such as a pickup truck, include a plurality of flat paint stencil sheets with each sheet including a plurality of irregularly-spaced apertures and the apertures of one sheet differing in shape and spacing than the apertures of the other sheets, and each sheet having a rear side with a magnetic backing member disposed thereon for adhering the sheet to the surface of the vehicle, and a camouflage paint stencil kit also including a set of gloves, masking tape, and one set of thin size spray strips and one set of larger size over spray strips for placement along the edges of the sheets to reduce over-spray.

### FIELD OF THE INVENTION

The present invention pertains to painting equipment and accessories, and more particularly pertains to a plurality of magnetic painting stencils that allows a hunter to custom paint a camouflage design on his/her vehicle.

### SUMMARY OF THE INVENTION

One of the most important aspects to any successful hunting operation or outing is the use of camouflage to enter the outdoor hunting area or environment, and then to use camouflage, among other techniques, to proceed on foot through the hunting area in search of the particular animal to be hunted. Since most hunters reach their hunting destination by vehicle, and then move from one area or environment to another by vehicle, it is desirable that the vehicle includes some type of camouflage pattern or coloring on its exterior. A standard or regular painted vehicle shines and reflects sunlight and is easily observed by humans let alone deer and other game. In addition, moving through wooded areas and terrain often results in damage to the vehicle's exterior finish from scratching and denting of the vehicle exterior from bushes, tree limbs and branches, and other irregularities of the terrain. Therefore, it is advantageous for the hunter to have some type of camouflage pattern or configuration applied or adhered to the major surfaces of the vehicle. Stealth is a critical component of any hunting excursion or expedition, and a vehicle with a camouflage coloring or pattern helps to reduce the ability of game to spot the approaching vehicle so they are not spooked off before the hunters can even begin the locating and stalking process.

One method of applying a camouflage pattern or configuration to the vehicle's surface areas is by hiring a professional auto painter. This is a very expensive proposition as the individual will have to pay for the labor and material, and the vehicle will often require multiple paint colors. In addition, the individual will have to work around the painter's schedule and be out of a vehicle for a period of time. Finally, not many professionals will interrupt their workload to tie up the paint bays for a long period of time in order to paint one vehicle.

A second method is for the individual to use a brush on paint scheme; however, this will produce an undesirable look and quality and be a messy process. This method also makes clean up more difficult. A third method is to use permanent stickers. However, this method is also more expensive and it is difficult to properly apply and install the stickers on the various parts, panels and surfaces of the vehicle. Moreover, permanent stickers are not truly permanent as wear, weather conditions, and other factors often require them to be replaced or fixed which is also expensive. Thus, the prior art discloses a number of camouflage pattern or configurations kits and methods of application thereof.

For example, the Tardif design patent (U.S. design patent D538,050 S) discloses a substrate with a camouflage pattern;

The Hasegawa patent (U.S. Pat. No. 4,528,906) discloses a system for retaining stencil printing on a printing drum that includes a stencil master that is clamped to the printing drum for printing thereon;

The Nesbitt patent (U.S. Pat. No. 5,549,938) discloses a removable camouflage panel having a particular pattern imprinted thereon and which is magnetically adhered to the various panels of the vehicle;

The Roskey patent (U.S. Pat. No. 5,931,522) discloses a magnetic vehicle body protection apparatus that includes a plurality of flexible magnetic sheets that can be cut to size to protect the various surfaces and panels of the vehicle and absorb any blows thereupon;

The Warner patent (U.S. Pat. No. 6,017,079) discloses a vehicle camouflage conversion kit that includes a plurality of pressure-sensitive adhesive backed panels that are adhered to a specific part, portion, or panel of the surface of the vehicle for providing a camouflage pattern thereon; and

The Morris patent (U.S. Pat. No. 6,595,575 B2) discloses protective and decorative vehicle body panels that are attached to the vehicle body to protect the body of the vehicle and which also include a visible decorative layer.

Nonetheless, despite the ingenuity of the above devices, there remains a need for an apparatus and method to give the surfaces of a vehicle, such as a pickup truck, a camouflage pattern so that the vehicle blends into the environment for hunting purposes.

### BACKGROUND OF THE INVENTION

The present invention comprehends a camouflage paint stencil kit for painting a vehicle, such as a pickup truck used for hunting, with camouflage patterns or configurations in a clean, practical, and convenient way so that the vehicle blends into the outdoor environment and does not prematurely spook any wildlife in the area, especially the wildlife that are to be hunted.

The camouflage paints stencil kit includes a plurality—at least three—paint stencils, and each stencil is a flat preferably rectangular-shaped sheet lightweight, portable, flexible, and easy to store, transport, clean and reuse. Each sheet includes four sides, a front side and an opposite rear side. A plurality of irregularly-shaped apertures are formed on the sheet with the irregularly-shaped apertures of one sheet being different in shape and spacing than the other sheets; and the sheets are numbered in the upper right hand corner “1”, “2” and “3”. Each sheet includes a magnetic backing member located on the rear side so that the sheet will firmly adhere to the surface of the vehicle's body during the painting process. The kit is formed by the inclusion of a set of gloves and masking tape for the individual doing the painting as well as a reusable zip lock bag for the storage and future use of the items. In addition, four sets of over spray strips can be includes with one set being the thin strip and one set being the larger-sized strip. The strips would be placed right over the edges of each paint stencil to reduce-over spray. It should be noted that there is no preferred way to place and adhere the paint stencils to the various surfaces of the vehicle; and thus the paint stencils can be rotated, angled or overlapped with respect to each for creating a limitless number of camouflage patterns on and about the exterior surface of the vehicle.

It is an objective of the present invention to provide camouflage paint stencils for painting automotive vehicles, such as pickup trucks, wherein cost savings are attained by obviating the need to hire professional auto painters, employ a brush on paint scheme or use permanent stickers.

It is another objective of the present invention to provide camouflage paint stencils for painting automotive vehicles, such as pickup trucks, that are lightweight and are easy to install and reinstall to and from vehicles.

It is still another objective of the present invention to provide camouflage paint stencils for painting automotive vehicles, such as pickup trucks, wherein time is not wasted in taping off and cutting the particular pattern to be painted on the vehicle in so far as the pattern is already supplied to the individual.

It is still yet another objective of the present invention to provide camouflage paint stencils for painting automotive vehicles, such as pickup trucks, that allow for easy cleanup and are reusable year after year.

Still another objective of the present invention is to provide camouflage paint stencils for painting automotive vehicles, such as pickup trucks, that allows the individual to spray right on top of the pattern for the most efficient use of the paint and one's time.

Still yet another objective of the present invention is to provide camouflage paint stencils for painting automotive vehicles, such as pickup trucks, wherein a selection of multiple stencil patterns are provided that correspond to and are appropriate for different environmental and countryside areas and landscapes.

Still yet a further objective of the present invention is to provide camouflage paint stencils for painting automotive vehicles, such as pickup trucks, wherein less paint is used during the painting process and thus resulting in less waste.

Yet another objective of the present invention is to provide camouflage paint stencils for painting automotive vehicles, such as pickup trucks, that avoids the problem of over spraying.

Yet still another objective of the present invention is to provide camouflage paint stencils for painting automotive vehicles, such as pickup trucks, wherein the stencils are easy to store and which provides a neater looking painting project.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the camouflage paint stencils of the present invention showing the different camouflage pattern or design of each sheet;

FIG. 2 is a front elevational view of the camouflage paint stencils of the present invention illustrating the pattern or configuration for the sheet labeled sheet number one;

FIG. 3 is front elevational view of the camouflage paint stencils of the present invention illustrating the pattern or configuration for the sheet labeled sheet number two;

FIG. 4 is a front elevational view of the camouflage paint stencils of the present invention illustrating the pattern or configuration for the sheet labeled sheet number three;

FIG. 5 is a side elevational view of the camouflage paint stencils of the present invention illustrating the placement of the sheets to the left hand driver's side of a pickup truck;

FIG. 6 is a perspective view of the camouflage paint stencils of the present invention illustrating the placement of one sheet about the front driver's side of the vehicle and about the front panel adjacent the front wheel;

FIG. 7 is a side elevational view of the camouflage paint stencils of the present invention taken along lines 7-7 of FIG. 4 illustrating the sheet and the magnetic backing applied thereto for placing and holding the sheet to the vehicle to be painted;

FIG. 8 is a front elevational view of the camouflage paint stencils of the present invention illustrating two thin size spray strips for protecting parts of the vehicle that are not to be painted; and

FIG. 9 is a front elevational view of the camouflage paint stencils of the present invention illustrating two larger size spray strips for protecting parts of the vehicle that are not to be painted.

### DETAILED DESCRIPTION OF THE PREFERRED EMBODIMENT

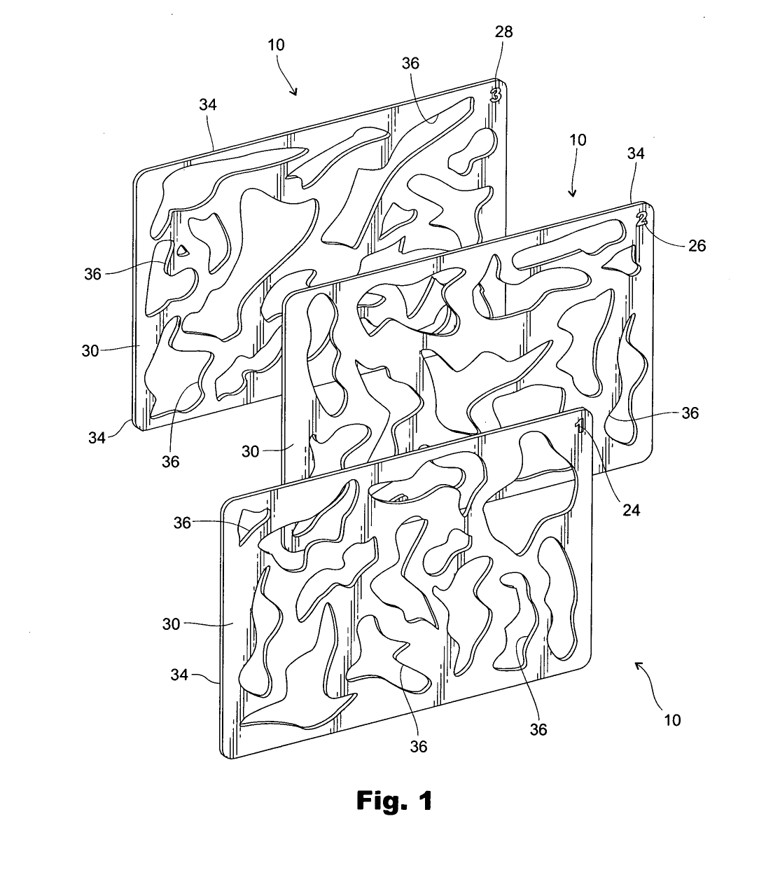

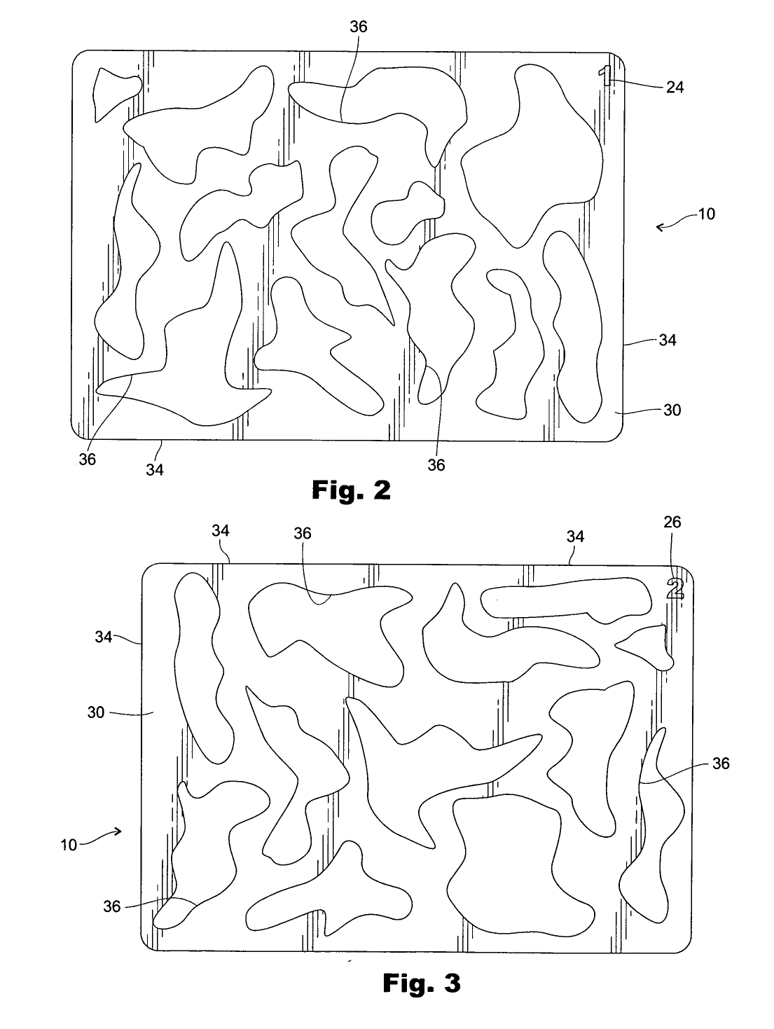

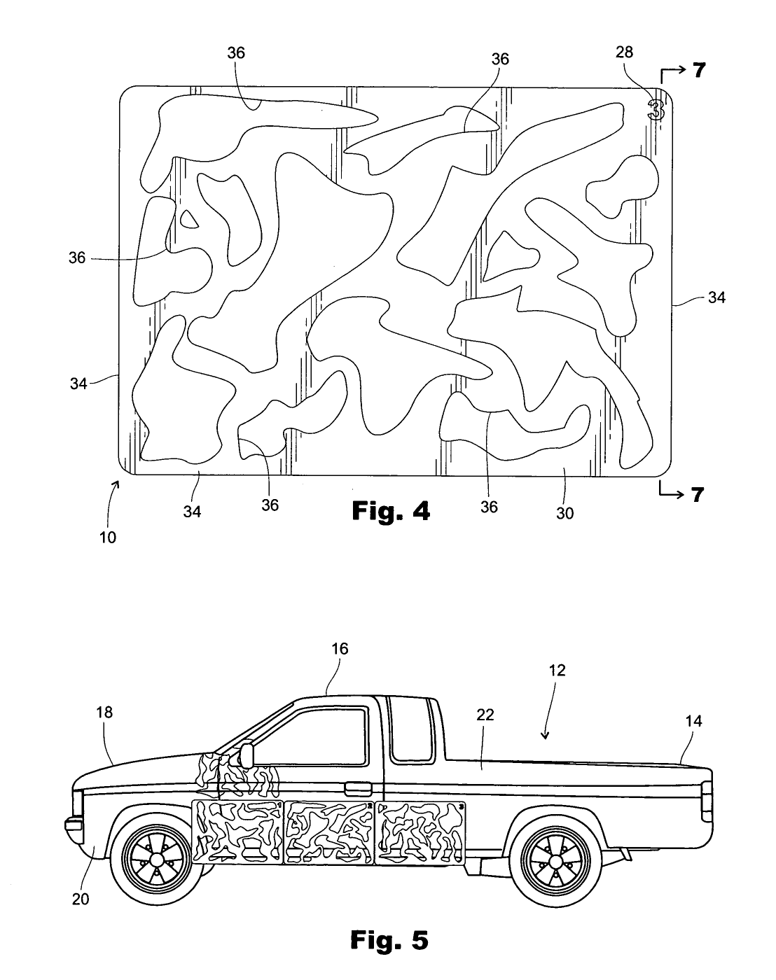

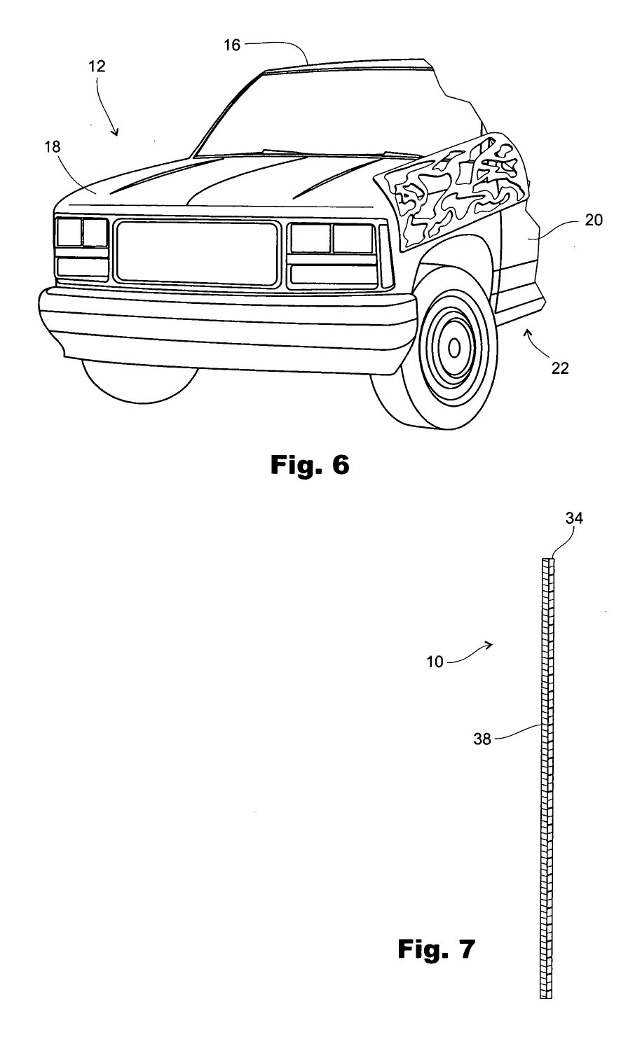

Illustrated in FIGS. 1-9 is a set—preferably at least three—of camouflage paint stencils in the form of individual portable, lightweight camouflage paint stencil sheets 10 that enable an individual that is an outdoorsman and hunter to custom paint a camouflage design, pattern or configuration on his/her vehicle so that the vehicle blends into the outdoor environment and reduces the chances that game in the area will be spooked by the vehicle. The automotive vehicle 12 is normally a pickup truck, such as the representative pickup truck shown in FIGS. 5 and 6. The pickup truck includes a bed 14, a cab 16, an engine hood 18, and left and right rear and front panels 20. All of these can be considered the exterior continuous surfaces 22 of the pickup truck 12, and all these exterior surfaces 22 can be painted with a camouflage pattern or configuration.

As shown in FIGS. 1-9 the camouflage paint stencils 10 can be included in a kit with other items hereinafter described with the primary element being the plurality of flat sheets or stencils 10. The flat stencils 10 can be rectangular-shaped or square-shaped, and have a thickness of between 30 to 40 millimeters and dimensions of either 18 inches by 24 inches or 12 inches by 18 inches. In the present embodiment the preferred numbered of sheets or stencils 10 is at least three, and as shown in FIG. 1, the sheets 10 are labeled in the upper right hand corner “1” 24, “2” 26, and “3” 28. Each sheet 10 includes a front side 30 and an opposite rear side 32 and is further defined by four continuous edges or sides 34.

As shown in FIGS. 1-9 each sheet or stencil 10 includes a plurality of irregularly spaced apertures 36 distributed throughout the body of each stencil 10. Moreover, the irregularly spaced and shaped apertures 36 of each stencil 10 are different from other the other stencils 10 thereby enhancing the randomness and uniqueness of the camouflage configuration or pattern painted on the vehicle 12. Each sheet or stencil 10 also includes a magnetic backing member 38 on the rear side 32, as shown FIG. 7, to securely adhere the stencil 10 to any desired exterior surface 22 of the vehicle 12 and to maintain the stencil 10 securely in place while the owner paints the camouflage design thereon.

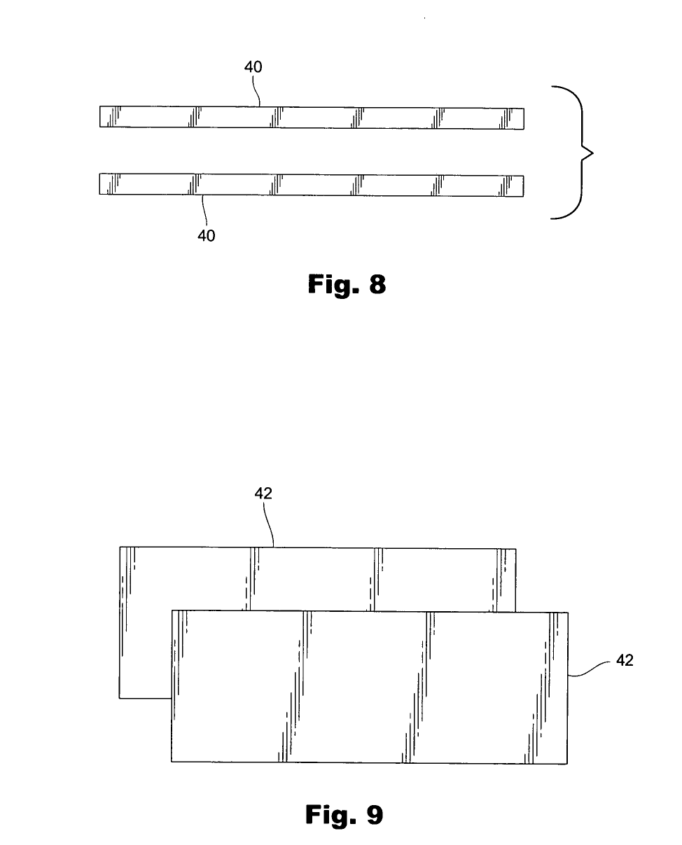

The camouflage paint stencils 10 can be included with other items and marketed and sold as a kit. The other items can include a set of rubber gloves and masking tape with the paint being supplied by the hunter/owner/customer. In addition, the packaging can include a reusable zip lock bag, appropriately sized, for the storage and future use of all the items. Furthermore, as shown in FIGS. 8 and 9, the kit can include over spray strips that are placed over the edges of each stencil in order to reduce the over-spray. More specifically, FIG. 8 shows four thin sized over spray strips 40 having the dimensions of 2 inches by 18 inches; FIG. 9 shows two larger size over spray strips 42 having the dimensions of 9 inches by 24 inches.

The following is one preferred method of using the camo paint stencils 10 to paint the vehicle 12 in a particular camouflage configuration. The vehicle 12 should be first prepped before painting; and this is done by scuffing up the surface area to be painted with a mild scratch pad or steel wool. Wash the vehicle and/or the areas to be painted, and then let the area to be painted and the vehicle 12 completely dry. Then mask off safety items with masking tape such as the windows, headlights, taillights, side mirrors, etc. Next, the individual should paint the whole vehicle 12 with a base line color of choice (the best color that would be comparable for the area the individual is going to be hunting in). The individual starts at one starting point and works his way around the vehicle 12 back to the same spot. For best results a flat non-reflective paint for all colors should be used.

Next, the individual will select the stencil or sheet 10 labeled “1” 24 and place that sheet 10 with the magnetic backing member 38 in contiguous adherence to the exterior surface area 22 to be first painted which defines the starting point. The paint is then sprayed right over and on top of that stencil 10. It should be noted that there is no specific predetermined way to place the sheets 10 on the exterior surface 22 of the vehicle 12. The sheets 10 can be rotated, angled, or overlapped with respect to each other and the surface 22 of the vehicle 12. By varying the placement of the sheets 10 in this manner all possible and unlimited number of camouflage patterns or configurations can be created. After this area is sprayed, the same sheet 10 is lifted and moved and placed upon the next adjoined location to be painted. The sheet 10 can be moved to different angles, and the sheet 10 does not have to be exactly where you left off and it is entirely okay to over lap. The process will continue until the whole vehicle 12 is done ending up where the individual started painting—the starting point. The above steps will be repeated for the sheets 10 labeled “2” 26 and “3” 28, and with different color paints. These sheets 10 will be placed in series right over the first set of patterns or configurations. The over lapping of the subsequent sheets 10 will achieve the finished camouflage appearance. After the last sheet 10—the sheet 10 labeled “3” 28—is used and the desired pattern or configuration covering is complete, the individual should let the vehicle 12 air-dry. After the paint is dry the cover up tape is removed from the above described safety item and other areas, and the vehicle 12 is ready to drive. For cleanup it should be noted that dry paint on the sheets 10 will not affect their future use, and the individual can paint right over the sheets 10 the next time the individual desires a different camouflage configuration or pattern. Finally, the individual should ensure that the sheets 10 are dry prior to storing them back in their original storage bag.

It will also be apparent to one skilled in the art that modifications may be made to the illustrated embodiment without departing from the spirit and scope of the invention as hereinafter set forth in the following appended claims.

I claim:

1. Camouflage paint stencils for painting a camouflage pattern on at the exterior surface of an automotive vehicle, comprising:
a plurality of flat, lightweight, flexible sheets;
each sheet including a front side, a back side, and a magnetic backing member on the back side;
each sheet further including a plurality of irregularly spaced and shaped apertures with the spacing and shape of each sheet differing from that of the other sheets;
the sheets being denoted in numerical order on their respective front sides commencing with one of the plurality of sheets having the designation “1” on its respective front side; and
whereupon each sheet is secured to the exterior surface of the automotive vehicle by the adherence of the magnetic backing member to the exterior surface and then paint is applied through the apertures to the exterior surface with the sheet being moved about the exterior surface for placement at the next adjoining location whereby paint is applied through the apertures onto the exterior surface until the sheet returns to its initial position and then the next sheet is secured to the exterior surface adjacent the initial position of the first sheet for the next application of paint so that the placement of all the sheets about the exterior surface and the application of paint through the respective apertures creates a distinct camouflage pattern on the exterior surface of the automotive vehicle.

2. The camouflage paint stencils of claim 1 wherein each sheet is rectangular-shaped.

3. The camouflage paint stencils of claim 2 further comprising a plurality of over spray strips that are placed along the edges of the sheets to reduce over painting on parts of the automotive vehicle are not to be painted.

4. The camouflage paint stencils of claim 3 wherein the over spray strips include at least one pair of thin size over spray strips and one pair of large size over spray strips.
